(19) United States
(12) Patent Application Publication
(10) Pub. No.: US 2008/0259542 A1
(43) Pub. Date: Oct. 23, 2008

(54) PLASMA DISPLAY

(75) Inventors: Chen-Tsun Juan, Hsinchu (TW); Kuo-Wen Chen, Hsinchu (TW); Yung-Chuan Tseng, Hsinchu (TW); Wu-Chen Huang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CORETRONIC CORPORATION, Hsinchu (TW)

(21) Appl. No.: 11/858,109

(22) Filed: Sep. 19, 2007

(30) Foreign Application Priority Data
Apr. 20, 2007 (TW) 96113968

(51) Int. Cl. G06F 1/16

(52) U.S. Cl. 361/681

(57) ABSTRACT

A plasma display including a shielding cover, a plasma display panel (PDP) and a circuit board is provided. The shielding cover includes a back plate and a frame, and the frame is connected to the back plate. The PDP is disposed inside the shielding cover and a gap is maintained between the PDP and the shielding cover. The circuit board is disposed between the PDP and the back plate. The shielding cover is grounded through the circuit board. The PDP is grounded via a single point grounding system through the circuit board.

### CROSS-REFERENCE TO RELATED APPLICATION

This application claims the priority benefit of Taiwan application serial no. 96113968, filed Apr. 20, 2007. All disclosure of the Taiwan application is incorporated herein by reference.

### BACKGROUND OF THE INVENTION

1. Field of the Invention

The present invention generally relates to a display, and more particularly, to a plasma display therein having a plasma display panel (PDP) featuring in single point grounding through a circuit board.

2. Description of Related Art

FIG. 1A is a schematic diagram of the structure of a conventional plasma display. FIG. 1B is a partially enlarged diagram of A portion of the conventional plasma display as shown in FIG. 1A. Referring to FIGS. 1A and 1B, a conventional plasma display 100 includes a casing 110, a plasma display panel (PDP) 120, a circuit board 130, a connection element 140, a power cord 150 and a base 160. The casing 110 includes a bezel 112, a frame 114, an optical filter 116 and a back cover 118. The frame 114 is disposed inside the bezel 112, while the optical filter 116 is connected between the bezel 112 and the frame 114. The bezel 112 and the optical filter 116 are connected to a side of the PDP 120 through the frame 114. In addition, the bezel 112 and the optical filter 116 are connected to the back cover 118 through the frame 114.

The circuit board 130 and the connection element 140 are disposed inside the casing 110, wherein the connection element 140 is connected between the back cover 118 and the PDP 120, while the circuit board 130 is connected to the back cover 118 and disposed between the back cover 118 and the PDP 120. The base 160 is disposed outside the casing 110 and connected to the back cover 118 to support the casing 110, the PDP 120 and the circuit board 130 in the weight direction. The power cord 150 is electrically connected to the circuit board 130, so that the back cover 118 and the PDP 120 are electrically connected to the power cord 150 via the circuit board 130 and further grounded via the power cord 150. Note that the edges of the PDP 120 is in contact with the frame 114 and the back cover 118, therefore, the electromagnetic wave generated from the PDP 120 during operation would be conducted to the circuit board 130 through the casing 110, and further grounded via the power cord 150. As a consequence, the conventional PDP 120 features in multipoint grounding system.

Since the frame 114 in the plasma display 100 is made of metal material, and the optical filter 116 and the PDP 120 contain metal material layers, thus, a shielding space is formed between the frame 114, the optical filter 116 and the PDP 120 as shown in FIG. 1B. Similarly, since the back cover 118 is made of metal material, and the PDP 120 is connected to the back cover 118, thus, another shielding space is formed between the back cover 118 and the PDP 120. Furthermore, the frame 114, the optical filter 116, the back cover 118 and the PDP 120 together form a shielding cover enclosing the PDP 120 at both sides of the PDP 120. The shielding cover is advantageous not only to shield an external electromagnetic wave and the interference thereof to promote the image quality of the PDP 120, but also to prevent an electromagnetic wave generated by the PDP 120 during operation from leaking out and harming the operators.

In order to avoid assembly gaps between the frame 114, the optical filter 116, the back cover 118 and the PDP 120 through which the electromagnetic waves penetrate or leak out during the operation of a conventional plasma display 100, conductive material 170, such as copper/aluminum foil tape, elastic piece, spacer, conductive rubber or conductive paint, is largely used to assemble the conventional plasma display 100. Thus, the higher cost of the conductive material 170 and the troublesome assembly requirement to fit the above-mentioned process make the conventional plasma display 100 more expensive.

### SUMMARY OF THE INVENTION

Accordingly, the present invention is directed a plasma display that can be manufactured comparatively at a lower cost.

The present invention is also directed to a plasma display having a plasma display panel (PDP) grounded via a single point grounding system through the circuit board thereof.

Other advantages of the present invention should be further indicated by the disclosures of the present invention, and omitted herein for simplicity.

To achieve one of, a part of or all advantages, an embodiment of the present invention provides a plasma display, which includes a shielding cover, a plasma display panel and a circuit board. The shielding cover includes a back plate and a frame, and the frame is connected to the back plate. The PDP is disposed inside the shielding cover and a gap is maintained between the PDP and the shielding cover. The circuit board is disposed between the PDP and the back plate, wherein the shielding cover is grounded through the circuit board. The PDP is grounded via a single point grounding system through the circuit board.

As embodied and broadly described herein, an embodiment of the present invention further provides a plasma display, which includes a shielding cover, a PDP, a first connection element and a circuit board. The shielding cover includes a back plate and a frame, the frame is connected to the back plate and the back plate is connected to the PDP through the first connection element. The PDP is disposed inside the shielding cover and a gap is maintained between the PDP and the shielding cover. The first connection element includes a conductive supporting element and an insulation material portion, wherein the conductive supporting element is electrically connected to the back plate and the insulation material portion encloses a part of the conductive supporting element, so that the conductive supporting element is insulated from the PDP by means of the insulation material portion. The circuit board is disposed between the PDP and the back plate.

The present invention also provides a plasma display, which includes a shielding cover, a PDP and a circuit board. The shielding cover includes a back plate and a frame connected to the back plate. The PDP is disposed inside the shielding cover and a gap is maintained between from the PDP and the shielding cover. The circuit board is disposed between the PDP and the back plate, wherein the shielding cover is grounded through the circuit board and the PDP is grounded via a single point grounding system through the shielding cover.

Since there is a gap maintained between the PDP and the shielding cover, and therefore there is no need to fill conductive material between the PDP and the shielding cover, which obviously saves the material and installation cost and thereby reduce the manufacture cost.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of the structure of a conventional plasma display.

FIG. 1B is a partially enlarged diagram of A portion of the conventional plasma display as shown in FIG. 1A.

FIG. 2A is a schematic diagram of the structure of a plasma display according to an embodiment of the present invention.

FIG. 2B is a partially enlarged diagram of B portion of the plasma display as shown in FIG. 2A.

FIG. 2C is partially enlarged diagram of C portion of the plasma display as shown in FIG. 2A.

FIG. 3A is a schematic view of the first connection element as shown in FIG. 2A.

FIG. 3B is a schematic view of the conductive supporting element as shown in FIG. 3A.

FIG. 3C is a schematic view of the insulation material portion as shown in FIG. 3A.

FIG. 4 is a schematic view of the second connection element as shown in FIG. 2A.

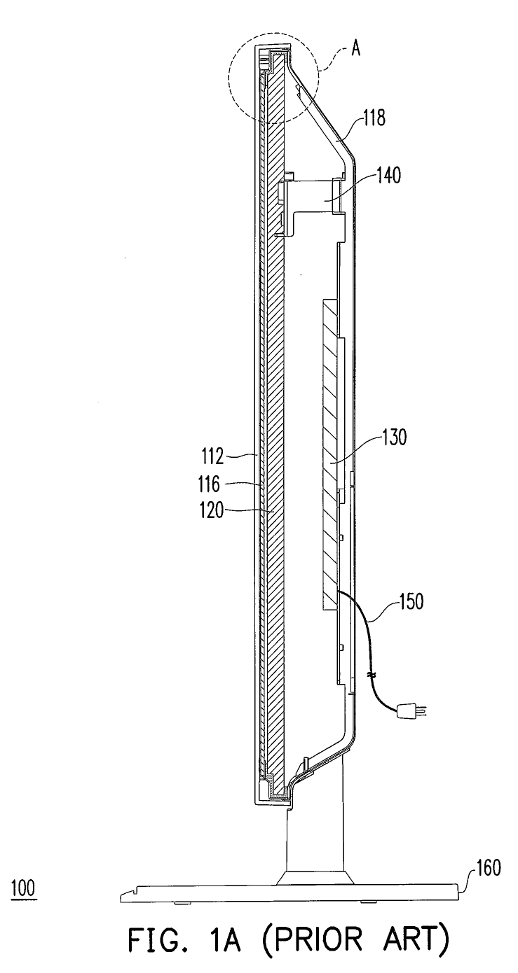

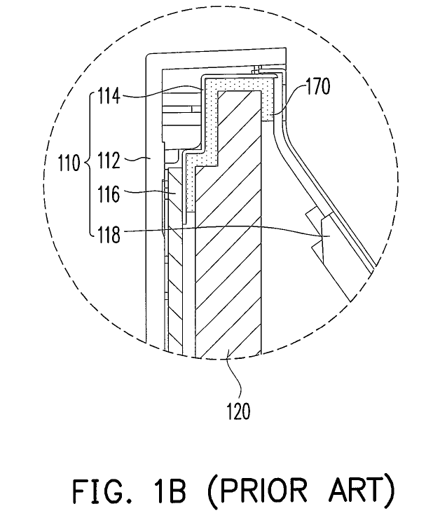

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the following detailed description of the preferred embodiments, reference is made to the accompanying drawings which form a part hereof, and in which is shown by way of illustration specific embodiments in which the invention may be practiced. In this regard, directional terminology is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Accordingly, the drawings and descriptions will be regarded as illustrative in nature and not as restrictive.

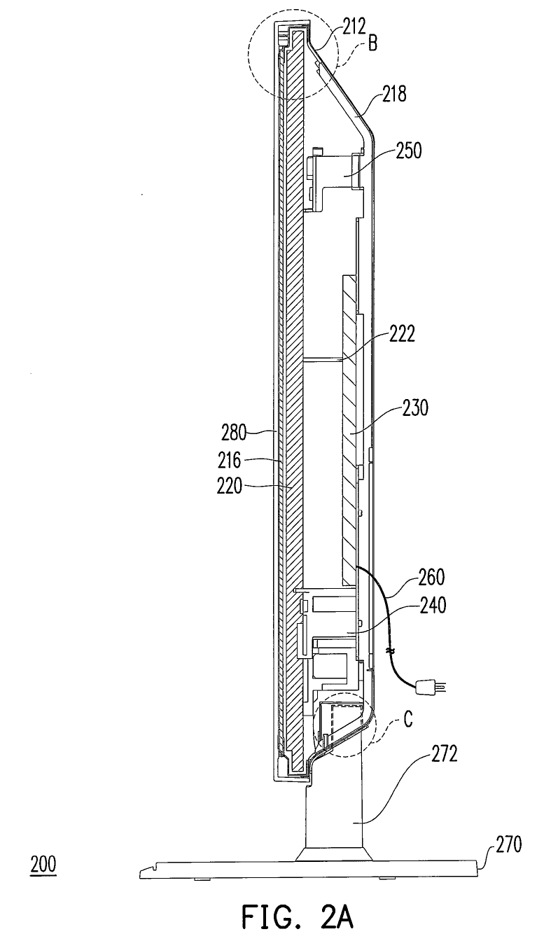

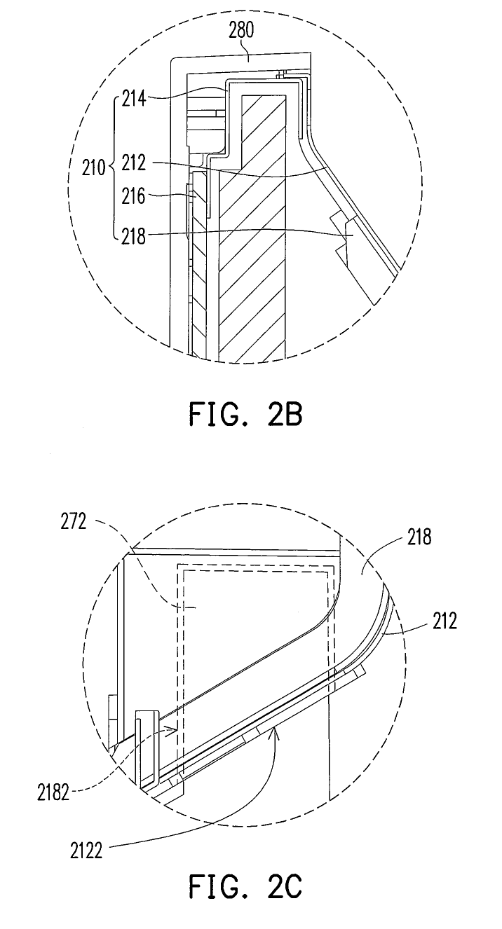

FIG. 2A is a schematic diagram of the structure of a plasma display according to an embodiment of the present invention. FIG. 2B is a partially enlarged diagram of B portion of the plasma display as shown in FIG. 2A. FIG. 2C is partially enlarged diagram of C portion of the plasma display as shown in FIG. 2A. Referring to FIGS. 2A to 2C, a plasma display 200 includes a shielding cover 210, a plasma display panel (PDP) 220, a circuit board 230, a first connection element 240, a second connection element 250, a power cord 260 and a base 270. The PDP 220 is disposed inside the shielding cover 210 and a gap is maintained between the PDP and the shielding cover 210. The PDP 220 is connected to a back plate 212 of the shielding cover 210 through the first connection element 240 and the second connection element 250 so as to keep the shielding cover 210 from being in contact with the PDP 220.

The circuit board 230 is disposed between the PDP 220 and the back plate 212 and electrically connected to the back plate 212. The power cord 260 is electrically connected to the circuit board 230, and the shielding cover 210 is grounded through the circuit board 230 and the power cord 260. In the present embodiment, the base 270 is connected to the PDP 220 through, for example, the first connection element 240 so as to support the shielding cover 210, the PDP 220 and the circuit board 230. However, the present invention does not limit thereto. For example, the base 270 is connected to the back plate 212, and the back plate 212 supports the shielding cover 210, the PDP 220 and the circuit board 230.

In the present embodiment, the shielding cover 210 includes a back plate 212, a frame 214 and an optical film 216, and the plasma display 200 further includes a bezel 280. The bezel 280 is disposed outside the optical film 216 for protecting the optical film 216, and the material of bezel 280 is comprised of, for example, plastic. The optical film 216 is located between the frame 214 and the bezel 280, and the optical film 216 and the bezel 280 are connected to the back plate 212 through the frame 214, wherein the materials of back plate 212 and the frame 214 are comprised of, for example, metal, the optical film 216 is, for example, a optical filter having a conductive material layer so as to form an electromagnetic shielding space enclosed by the back plate 212, the frame 214 and the optical film 216.

In order to reinforce the back plate 212, the shielding cover 210 in the embodiment can further include a back plate supporting element 218 disposed inside the shielding cover 210 and connected to the back plate 212. The PDP 220 is connected to the back plate supporting element 218 through, for example, the first connection element 240 and the second connection element 250. However, the present invention does not limit thereto. For example, when the strength of the back plate 212 is sufficient, the shielding cover 210 does not include the back plate supporting element 218, or the back plate 212 is integrally formed with the back plate supporting element 218.

The materials of the first connection element 240 and the second connection element 250 include, for example, insulation material, so that the PDP 220 is not electrically connected to the shielding cover 210 via the first connection element 240 and the second connection element 250. Accordingly, the PDP 220 can be insulated from the shielding cover 210 by means of the first connection element 240 and the second connection element 250 so as to make the shielding cover 210 have electromagnetic shielding function. The structures of the first connection element 240 and the second connection element 250 would be described respectively by an implementation hereafter. Note that the present invention does not limit to the design of two connection elements (i.e., the first connection element 240 and the second connection element 250). In fact, the present invention allows a design with more than or less than two connection elements.

The PDP 220 can have a grounding wire 222, through which the PDP 220 is electrically connected to the circuit board 230 at a single connection point, where the electrical connection between the power cord 260 and the circuit board 230 would ground the PDP 220 via a single point grounding system through the power cord 260.

However, the present invention is not limited to the above-described embodiment. For example, the grounding wire 222 is connected to the shielding cover 210 instead of the circuit board 230, and the PDP 220 is electrically connected to the shielding cover 210 at a single connection point through the grounding wire 222. At this point, the electrical connection between the shielding cover 210 and the power cord 260 through the circuit board 230 grounds the PDP 220 via a single point grounding system through the power cord 260. Alternatively, the grounding wire 222 can be disposed inside the first connection element 240 or the second connection element 250, so that the PDP 220 is electrically connected to the shielding cover 210 through the grounding wire 222 at a single connection point.

Compared to the conventional plasma display 100, the PDP 220 according to an embodiment of the present invention is connected to the shielding cover 210 only through, for example, the first connection element 240 and the second connection element 250 and is insulated from the shielding cover 210 by means of the first connection element 240 and the second connection element 250. Thus, the electromagnetic wave generated from the PDP 220 during operation is conducted there-from through the grounding wire 222 and a single point grounding system is established. Accordingly, a single point grounding system is established.

In addition, the present invention is not limited to the above-mentioned structure that the base 270 supports the shielding cover 210, the PDP 220 and the circuit board 230. For example, the base 270 may be omitted, and the shielding cover 210 may be utilized to support the PDP 220 and the circuit board 230. Alternatively, the shielding cover 210 may be integrally formed with the base 270. Moreover, for example, the plasma display 200 of the present invention further includes a suspension device (not shown). The suspension device is connected to the shielding cover 210, so that the plasma display 200 is hung on a wall or under a ceiling.

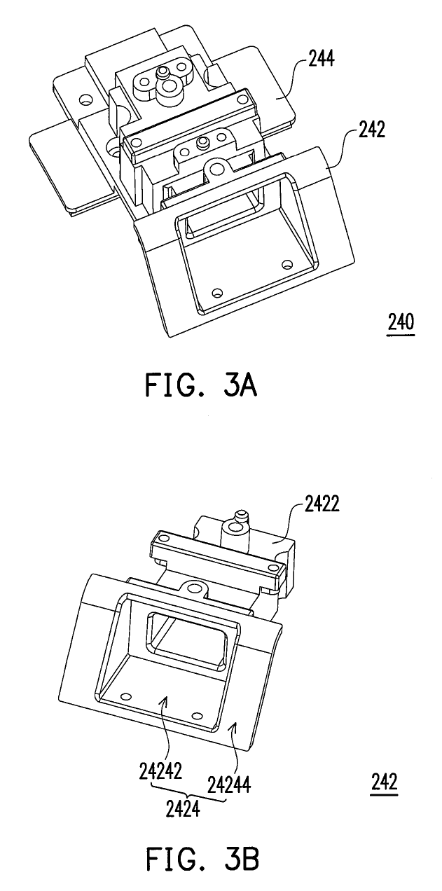

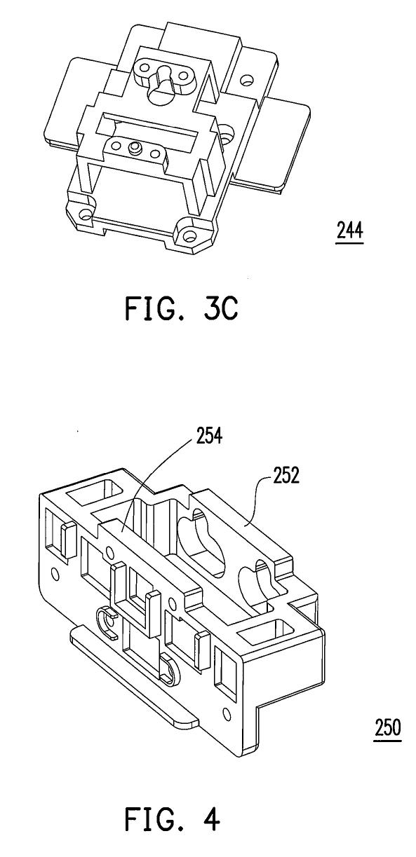

FIG. 3A is a schematic view of the first connection element as shown in FIG. 2A, wherein the first connection element 240 includes a conductive supporting element 242 and an insulation material portion 244. FIG. 3B is a schematic view of the conductive supporting element as shown in FIG. 3A and FIG. 3C is a schematic view of the insulation material portion as shown in FIG. 3A. Referring to FIGS. 2A and 3A, the conductive supporting element 242 is electrically connected to the back plate 212, while the insulation material portion 244 is connected to the PDP 220 and encloses a part of the conductive supporting element 242, so that the conductive supporting element 242 is insulated from the PDP 220 by means of the insulation material portion 244.

In the present embodiment, the first connection element 240 may be fabricated by a process described below. First, the conductive supporting element 242 is formed by foundry. Next, the insulation material portion 244 is formed by an insert molding process outside the conductive supporting element 242 so as to complete the first connection element 240.

Referring to FIGS. 3A to 3C, the conductive supporting element 242 includes a connection portion 2422 and an accommodating portion 2424, wherein the accommodating portion 2424 is connected to the connection portion 2422. The insulation material portion 244 encloses a part of the connection portion 2422 and exposes the accommodating portion 2424, so that the conductive supporting element 242 is able to be electrically connected to an inner side surface of the back plate 212 (as shown in FIG. 2A) through a surface 24244 of the accommodating portion 2424. The connection portion 2422 and an accommodating portion 2424 are insulated from the PDP 220 (as shown in FIG. 2A) by means of the insulation material portion 244. Similarly, conductive materials, such as copper/aluminum foil tape, elastic piece, spacer, conductive rubber or conductive paint, are disposed or coated on the surface 24244 of the accommodating portion 2424 and the inner side surface of the back plate 212 (as shown in FIG. 2A) to increase the connection close-fitness between the above-mentioned two surfaces and to further avoid electromagnetic waves to penetrate into or leak out of the shielding cover 210 (as shown in FIG. 2A).

Referring to FIGS. 2C and 3B, in the present embodiment, the accommodating portion 2424 further comprises a cavity 24242 which is extended from the surface 24244 towards the connection portion 2422. The back plate 212 has a first opening 2122, the back plate supporting element 218 has a second opening 2182 and the base 270 (as shown in FIG. 2A) has a supporting post 272. The cavity 24242 is aligned with the first opening 2122 and the second opening 2182, and the supporting post 272 passes through the first opening 2122 and the second opening 2182 and is inserted into the cavity 24242. Thus, referring to FIGS. 2A and 2B, the base 270 is able to support the shielding cover 210, the PDP 220 and the circuit board 230 by means of the first connection element 240.

Besides, referring to FIGS. 2C to 3B, although the shielding cover 210 shown in FIG. 2B would cause an antenna effect at the first opening 2122 and the second opening 2182 to make electromagnetic waves penetrate in or leak out, since the cavity 24242 and the surface 24244 would cover the first opening 2122 and the second opening 2182, the conductive supporting element 242 still is able to reduce the impact of the antenna effect.

FIG. 4 is a schematic view of the second connection element as shown in FIG. 2A. Referring to FIGS. 2A and 4, the second connection element 250 includes a first connection portion 252 and a second connection portion 254. The first connection portion 252 is connected to the back plate 212 by using a fastening member (not shown), while the second connection portion 254 is connected to the PDP 220 by using a fastening member (not shown), wherein the above-mentioned fastening members are, for example, screws. Since the second connection element 250 is made of insulation material, and the fastening member connecting the back plate 212 and the fastening member connecting the PDP 220 are not electrically connected to each other, thus, the back plate 212 can be indirectly connected to the PDP 220 through the second connection element 250 so as to keep an interval between the back plate 212 and the PDP 220. In addition, the above-mentioned structure is able to make the back plate 212 insulated from the PDP 220 due to the second connection element 250 disposed there-between.

In summary, according to an embodiment of the present invention, since there is a gap between the shielding cover and the PDP, thus, there is no need to fill conductive material between the PDP and the shielding cover, which obviously saves the material and assembly cost of a plasma display. Besides, although the shielding cover would cause an antenna effect at the first opening and the second opening, since the cavity and the surface of the conductive supporting element would cover the first opening and the second opening, the conductive supporting element is able to reduce the impact of the antenna effect.

In addition, the plasma display further includes an insulation material (not shown) between the shielding cover and the PDP to avoid an accidental contact between the shielding cover and the PDP to form electrical connections at multiple connection points. The insulation material is, for example, rubber. Therefore, according to the present invention, above-mentioned gaps between the shielding cover and the PDP may be filled with insulation material.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A plasma display, comprising:
a shielding cover, comprising:
a back plate; and
a frame, connected to the back plate;
a plasma display panel, disposed inside the shielding cover, wherein a gap is maintained between the plasma display panel and the shielding cover; and
a circuit board, disposed between the plasma display panel and the back plate, wherein the shielding cover is grounded through the circuit board and the plasma display panel is grounded via a single point grounding system through the circuit board.

2. The plasma display according to claim 1, further comprising a bezel connected to the back plate through the frame.

3. The plasma display according to claim 2, wherein the shielding cover further comprises an optical film disposed inside the bezel and located between the bezel and the frame.

4. The plasma display according to claim 3, wherein the optical film comprises an optical filter.

5. The plasma display according to claim 4, wherein the optical filter has a conductive material layer.

6. The plasma display according to claim 1, further comprising a first connection element, wherein the back plate is connected to the plasma display panel through the first connection element, and the first connection element comprises:
a conductive supporting element, electrically connected to the back plate; and
an insulation material portion, enclosing a part of the conductive supporting element, for insulating the conductive supporting element from the plasma display panel.

7. The plasma display according to claim 6, wherein the first connection element is integrally formed.

8. The plasma display according to claim 6, further comprising a base, wherein the base has a supporting post, the back plate has a first opening and the supporting post passes through the first opening and is connected to the conductive supporting element to support the plasma display panel, the shielding cover and the circuit board.

9. The plasma display according to claim 8, wherein the conductive supporting element comprises:
a connection portion; and
an accommodating portion, connected to the connection portion, comprising a cavity extending from a surface thereof towards the connection portion, wherein the insulation material portion encloses a part of the connection portion and exposes the accommodating portion, and the supporting post passes through the first opening and is inserted into the cavity.

10. The plasma display according to claim 9, further comprising a back plate supporting element disposed inside the shielding cover and connected to the back plate, wherein the back plate is connected to the plasma display panel through the first connection element and the back plate supporting element, the back plate supporting element has a second opening and the supporting post passes through the first opening and the second opening and is inserted into the cavity.

11. The plasma display according to claim 10, further comprising a second connection element, wherein the plasma display panel is connected to the back plate supporting element through the second connection element.

12. The plasma display according to claim 1, further comprising a power cord electrically connected to the circuit board, wherein the shielding cover is grounded through the circuit board and the power cord, and the plasma display panel is grounded via a single point grounding system through the circuit board and the power cord.

13. The plasma display according to claim 12, wherein the plasma display panel is electrically connected to the circuit board at a single connection point via a grounding wire.

14. A plasma display, comprising:
a shielding cover, comprising:
aback plate; and
a frame, connected to the back plate;
a plasma display panel, disposed inside the shielding cover, wherein a gap is maintained between the plasma display panel and the shielding cover;
a first connection element, wherein the back plate is connected to the plasma display panel through the first connection element, and the first connection element comprises:
a conductive supporting element, electrically connected to the back plate; and
an insulation material portion, enclosing a part of the conductive supporting element, for insulating the conductive supporting element from the plasma display panel; and
a circuit board, disposed between the plasma display panel and the back plate.

15. The plasma display according to claim 14, further comprising a bezel connected to the back plate through the frame.

16. The plasma display according to claim 15, wherein the shielding cover further comprises an optical film disposed inside the bezel and located between the bezel and the frame.

17. The plasma display according to claim 16, wherein the optical film comprises an optical filter.

18. The plasma display according to claim 17, wherein the optical filter has a conductive material layer.

19. The plasma display according to claim 14, wherein the first connection element is integrally formed.

20. The plasma display according to claim 14, further comprising a base, wherein the base has a supporting post, the back plate has a first opening and the supporting post passes through the first opening and is connected to the conductive supporting element to support the plasma display panel, the shielding cover and the circuit board.

21. The plasma display according to claim 20, wherein the conductive supporting element comprises:
a connection portion; and
an accommodating portion, connected to the connection portion, comprising a cavity extending from a surface thereof towards the connection portion, wherein the insulation material portion encloses a part of the connection portion and exposes the accommodating portion, and the supporting post passes through the first opening and is inserted into the cavity.

22. The plasma display according to claim 21, further comprising a back plate supporting element disposed inside the shielding cover and connected to the back plate, wherein the back plate is connected to the plasma display panel through the first connection element and the back plate supporting element, the back plate supporting element has a second opening and the supporting post passes through the first opening and the second opening and is inserted into the cavity.

23. The plasma display according to claim 22, further comprising a second connection element, wherein the plasma display panel is connected to the back plate supporting element through the second connection element.

24. The plasma display according to claim 14, wherein the shielding cover is grounded through the circuit board and the plasma display panel is grounded via a single point grounding system through the circuit board.

25. The plasma display according to claim 24, further comprising a power cord electrically connected to the circuit board, wherein the shielding cover is grounded through the circuit board and the power cord, and the plasma display panel is grounded via a single point grounding system through the circuit board and the power cord.

26. The plasma display according to claim 14, wherein the plasma display panel is electrically connected to the shielding cover at a single connection point via a grounding wire.

27. A plasma display, comprising:
a shielding cover, comprising:
a back plate; and
a frame, connected to the back plate;
a plasma display panel, disposed inside the shielding cover, wherein a gap is maintained between the plasma display panel and the shielding cover; and
a circuit board, disposed between the plasma display panel and the back plate, wherein the shielding cover is grounded through the circuit board and the plasma display panel is grounded via a single point grounding system through the shielding cover.

28. The plasma display according to claim 27, wherein the plasma display panel is electrically connected to the shielding cover at a single connection point via a grounding wire.
